(19) United States
(12) Patent Application Publication
(10) Pub. No.: US 2026/0131757 A1
(43) Pub. Date: May 14, 2026

(54) PERIODIC ADJUSTMENT OF SHOULDER BELT OF SEATBELT ASSEMBLY

(71) Applicant: Ford Global Technologies, LLC, Dearborn, MI (US)

(72) Inventors: Brendan Francis Diamond, Naples, FL (US); Keith Weston, Canton, MI (US); Michael Alan McNees, Flat Rock, MI (US); Andrew Brown, Royal Oak, MI (US); Anthony Maraldo, Southgate, MI (US)

(73) Assignee: Ford Global Technologies, LLC, Dearborn, MI (US)

(21) Appl. No.: 18/946,257

(22) Filed: Nov. 13, 2024

(51) Int. Cl. B60R 22/20; B60R 22/48

(52) U.S. Cl. CPC B60R 22/201; B60R 22/48; B60R 2022/208

(57) ABSTRACT

A computer has a processor and memory storing instructions executable by the processor to: detect a position of an occupant in a vehicle; identify a set of target positions of a shoulder-belt anchor of a seatbelt assembly based on the position of the occupant; and periodically move the shoulder-belt anchor between various ones of the target positions.

### BACKGROUND

Vehicles include seatbelt assemblies for each of the seats onboard. The seatbelt assembly includes webbing that, when the seatbelt assembly is buckled, extends across an occupant of the seat. A lap-belt anchor attaches one end of the webbing to a seat frame or a vehicle body. The other end of the webbing feeds into a retractor, which includes a spool that pays out and retracts the webbing. The retractor may be mounted to the vehicle body, e.g., to a pillar of the vehicle body. A clip slides freely along the webbing and, when engaged with a buckle, divides the webbing into a lap belt and a shoulder belt.

Some seatbelt assemblies include a shoulder-belt anchor at an upper end of the shoulder belt. In some examples, the shoulder-belt anchor is between the shoulder belt and the retractor and the webbing slides relative to the shoulder-belt anchor. In some examples, the shoulder-belt anchor is vertically adjustable relative to the vehicle body to adjust the position of the upper end of the shoulder belt relative to the occupant. The shoulder-belt anchor can be adjustable by mechanical input by the occupant and/or by electronic input to control a motor that adjusts the shoulder-belt anchor.

### BRIEF DESCRIPTION OF THE DRAWINGS

FIG. 1 is a perspective view of a vehicle including an adjustable shoulder-belt anchor.

FIG. 2 is a block diagram of a system of the vehicle.

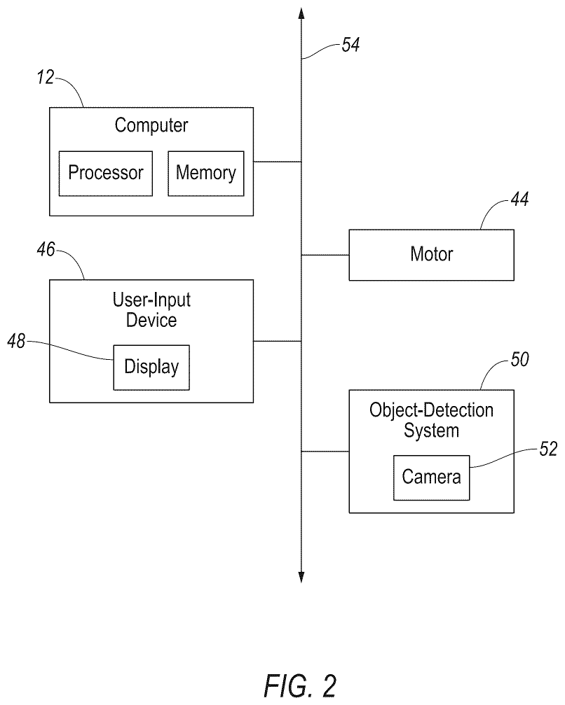

FIG. 3 is a flow chart of an example method.

### DETAILED DESCRIPTION

A computer has a processor and memory storing instructions executable by the processor to: detect a position of an occupant in a vehicle; identify a set of target positions of a shoulder-belt anchor of a seatbelt assembly based on the position of the occupant; and periodically move the shoulder-belt anchor between various ones of the target positions.

The instructions may include instructions to update the set of target positions based on user-based input.

The instructions may include instructions to update the set of target positions based on detection of indicators of irritation of the occupant by a shoulder belt of the seatbelt assembly.

The instructions include instructions to update the set of target positions based on detection of images indicating irritation of the occupant by a shoulder belt of the seatbelt assembly.

The instructions include instructions to update the set of target positions based on manual adjustment of a position of the shoulder-belt anchor by the occupant.

The instructions include instructions to modify the frequency of periodic movement of the shoulder belt based on vibration of a body of the vehicle.

The instructions include instructions to update the set of target positions based on a change in the position of the occupant in the vehicle.

The instructions include instructions to update the set of target positions based on: detection of images indicating irritation of the occupant by a shoulder belt of the seatbelt assembly; manual adjustment of a position of the shoulder-belt anchor by the occupant; and change in the position of the occupant in the vehicle.

A method includes: detecting a position of an occupant in a vehicle; identifying a set of target positions of a shoulder-belt anchor of a seatbelt assembly based on the position of the occupant; and periodically moving the shoulder-belt anchor between various ones of the target positions.

The method may include updating the set of target positions based on user-based input.

The method may include updating the set of target positions based on detection of indicators of irritation of the occupant by a shoulder belt of the seatbelt assembly.

The method may include updating the set of target positions based on detection of images indicating irritation of the occupant by a shoulder belt of the seatbelt assembly.

The method may include updating the set of target positions based on manual adjustment of a position of the shoulder-belt anchor by the occupant.

The method may include modifying the frequency of periodic movement of the shoulder belt based on vibration of a body of the vehicle.

The method may include updating the set of target positions based on a change in the position of the occupant in the vehicle.

The method may include updating the set of target positions based on: detection of images indicating irritation of the occupant by a shoulder belt of the seatbelt assembly; manual adjustment of a position of the shoulder-belt anchor by the occupant; and change in the position of the occupant in the vehicle.

With reference to the Figures, wherein like numerals indicate like parts throughout the several views, a computer 12 has a processor and memory storing instructions executable by the processor to: detect a position of an occupant in a vehicle 10; identify a set of target positions of a shoulder-belt anchor 14 of a seatbelt assembly 16 based on the position of the occupant; and periodically move the shoulder-belt anchor 14 between various ones of the target positions.

The movement of the shoulder-belt anchor 14 between various ones of the target positions adjusts the position of a shoulder belt 18 of the seatbelt assembly 16 relative to the occupant. The shoulder belt 18 may be adjusted upwardly or downwardly relative to the occupant. The set of target positions accommodates for the operation of the seatbelt assembly 16 and comfort of the occupant. The periodic movement of the shoulder-belt anchor 14 between target positions in the set of target positions can reduce discomfort sensed by the occupant by prolonged placement of the shoulder belt 18 across the same part of the shoulder and/or torso of the occupant. Since the set of target positions is based on the position of the occupant, the boundaries of the set of target positions changes as the occupant moves to a different posture, e.g., as the passenger slouches, sits straight, leans to one side, adjusts a seat 24 upon which the occupant is seat 24ed, etc. The boundaries of the set of target positions may be dynamically updated based on movement of the occupant. The set of target positions may be adjusted based on inputs identifying irritation of the occupant by the shoulder belt 18, e.g., as detected by manual adjustment of the shoulder-belt anchor 14 by the occupant and/or indications of discomfort by the occupant. Occupant-specific adjustments to the set of target positions may be stored and applied for future use by the occupant.

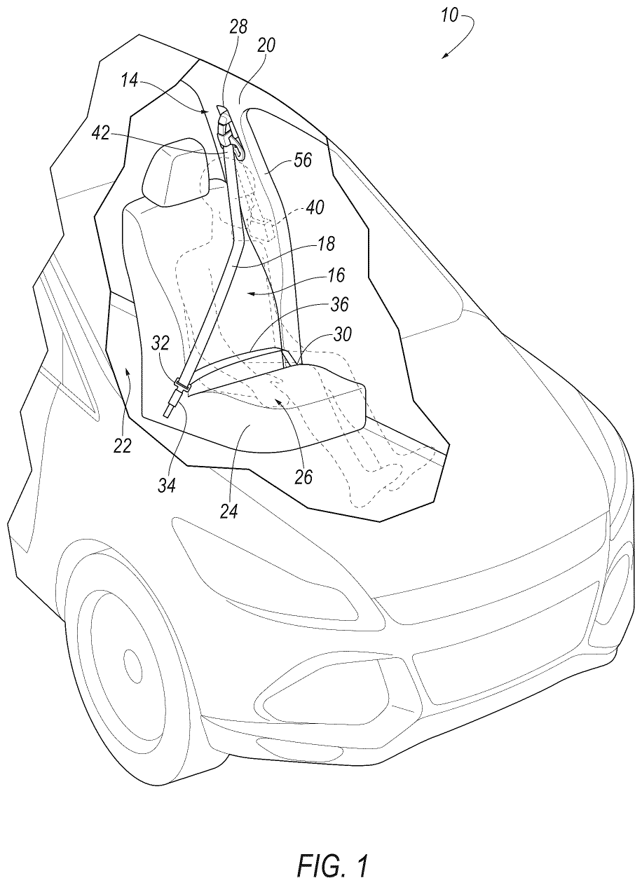

With reference to FIG. 1, the vehicle 10 may be any suitable type of ground vehicle, e.g., a passenger or commercial automobile such as a sedan, a coupe, a truck, a sport utility, a crossover, a van, a minivan, a taxi, a bus, etc. The vehicle 10 defines a vehicle-longitudinal axis extending between a front end and a rear-end of the vehicle 10. The vehicle 10 defines a cross-vehicle axis extending cross-vehicle from one side to the other side of the vehicle 10. The vehicle 10 defines a vertical axis extending through a floor and ceiling of the vehicle 10. The vehicle-longitudinal axis, the cross-vehicle axis, and the vertical axis are perpendicular relative to each other. The vehicle 10 includes a vehicle frame (not numbered) and a vehicle body 20 (not numbered). The vehicle frame and/or the vehicle body 20 defines an occupant cabin 22 to house occupants of the vehicle 10. The occupant cabin 22 may extend across the vehicle 10, i.e., from one side to the other side of the vehicle 10. The vehicle body 20 may include pillars 56.

The vehicle 10 includes one or more seats 24 in the occupant cabin 22. The seats 24 may be arranged in any suitable manner in the occupant cabin 22. The seatback may define an occupant-seating area 26. The occupant may be disposed in the occupant-seating area 26, as shown in the Figures.

The vehicle 10 includes one or more seatbelt assemblies 16. The seatbelt assemblies 26 each include a seatbelt retractor 40 and the webbing extendable from the seatbelt retractor 40. The vehicle 10 may include any suitable number of seatbelt assemblies 16, i.e., one seatbelt assembly 16 for each occupant-seating area 26.

The seatbelt assembly 16, when fastened, is designed to control the kinematics of the occupant during certain vehicle impacts or sudden stops. The seatbelt assembly 16 includes a lap-belt anchor 30 coupled to the webbing, the adjustable shoulder-belt anchor 14, and a clip 32 between the lap-belt anchor 30 and the adjustable shoulder-belt anchor 14 to engage a buckle 34. The clip 32 slides freely along the webbing and, when engaged with the buckle 34, divides the webbing into a lap belt 36 and the shoulder belt 18. In such an example, the lap belt 36 extends across the lap of the occupant, e.g., from the lap-belt anchor 30 to the clip 32, and the shoulder belt 18 extends in an upward direction from the clip 32 to the shoulder-belt anchor 14. The seatbelt assembly 16 may be a three-point harness, meaning that the webbing is attached at three points around the occupant when fastened. The seatbelt assembly 16 may, in other examples, include another arrangement of attachment points. The webbing may be fabric, e.g., polyester. The hardware of the seatbelt assembly 16 (i.e., the seatbelt retractor 40, the webbing, the lap-belt anchor 30, and the shoulder-belt anchor 14) may be, in some examples, a conventional type.

In the example shown in the Figures, the webbing extends continuously from the seatbelt retractor 40 to the lap-belt anchor 30. Specifically, the webbing extends from the seatbelt retractor 40 along the pillar 56 to the adjustable shoulder-belt anchor 14, from the adjustable shoulder-belt anchor 14 to the clip, and from the clip to the lab-belt anchor.

The seatbelt retractor 40 provides payout and retraction of the webbing, e.g., via rotation of a spool of the seatbelt retractor 40. The seatbelt retractor 40 may be mounted at any suitable location in the vehicle 10, e.g., the pillar 56 in the example shown in the Figures. A housing of the seatbelt retractor 40 is fixed to the body 20 of the vehicle 10, i.e., is immovable relative to the body 20 of the vehicle 10, and the webbing extends from and retracts into the housing. Specifically, one end of the webbing feeds into the seatbelt retractor 40, and the other end of the webbing is fixed to the lap-belt anchor 30 in the example shown in the Figures.

In the example shown in the Figures, the lap-belt anchor 30 is fixed to the vehicle body 20, e.g., the pillar 56, the floor, etc. In other words, the lap-belt anchor 30 is immovable relative to the body 20 of the vehicle 10.

The adjustable shoulder-belt anchor 14 is mounted to the body 20 of the vehicle 10, as shown in FIG. 1. The adjustable shoulder-belt anchor 14 defines the upper end 42 of the shoulder belt 18. In the example, shown in the Figures, the webbing is slidable through the adjustable shoulder-belt anchor 14. In other examples, the upper end 42 of the shoulder belt 18 may be fixed to the adjustable shoulder-belt anchor 14.

The adjustable shoulder-belt anchor 14 is vertically adjustable along the body 20, e.g., the pillar 56, to vertically adjust the upper end 42 of the shoulder belt 18 of the webbing. In other words, the adjustable shoulder-belt anchor 14 may be adjusted to a selected vertical position and locked relative to the body 20 in that selected vertical position. “Vertical adjustment” is movement of the adjustable shoulder-belt anchor 14 upwardly and downwardly with a vertical component of movement to adjust the height of the upper end 42 of the shoulder belt 18 relative to the occupant. The movement of the adjustable shoulder-belt anchor 14 may be both manually controlled by the occupant and automatically controlled by the computer 12, as described further below.

The adjustable shoulder-belt anchor 14 may include a motor 44 and a guide 28, and in some examples includes a motor 44 and a guide 28 of known types. The guide 28 supports the upper end 42 of the shoulder belt 18 and the motor 44 moves the guide 28 up and down relative to the body 20 to adjust the position of the shoulder belt 18 on the occupant. The guide 28 may be a D-ring, including those that are currently known as guides for shoulder belts. The motor 44 is mounted to the body 20 of the vehicle 10, e.g., the pillar 56. Specifically, a housing of the motor 44 is fixed to the body 20 of the vehicle 10, i.e., is immovable relative to the body 20 of the vehicle 10. The motor 44 may be of any suitable type, e.g., a DC motor. The motor 44 is in communication with the computer 12 so that the computer 12 can control the operation of the motor 44.

The adjustable shoulder-belt anchor 14, e.g., at least the motor 44, includes a linear actuator that moves the guide 28 relative to the body 20, including movement between various ones of the target positions. As one example, the guide 28 may be in a track on the body 20 that allows for vertical movement of the guide 28 relative to the body 20, and the motor 44 may include a drive screw that his threadedly engaged a threaded hole of the guide 28 to move the guide 28 along the track, including between various ones of the target positions.

The vehicle 10 includes a user-input device 46 to manually adjust the adjustable shoulder-belt anchor 14. The occupant may provide input to the user-input device 46 to selectively raise or lower the adjustable shoulder-belt anchor 14 to a desired position. For example, based on manual input by the occupant to the user-input device 46, the computer 12 controls the position of the adjustable shoulder-belt anchor 14. As an example, the user-input device 46 may be an electro-mechanical toggle, button, switch, etc. As another example, the user-input device 46 may include a display 48 that allows for user interaction. For example, the display 48 may be a conventional touchscreen display, such that a user may provide input to the computer 12 via a display screen. For example, the touchscreen may be any suitable type for receiving an input from a user (e.g., resistive, capacitive, infrared, etc.).

The vehicle 10 includes an interior object-detection system 50. The interior object-detection system 50 identifies the presence of objects in the occupant cabin 22. As an example, the interior object-detection system 50 may identify an occupant in the occupant cabin 22 and, in such examples, may identify the location of at least some parts of the occupant. For example, the interior object-detection system 50 may identify the location of a shoulder of the occupant, a torso of the occupant, a head of the occupant, etc. In such examples, the interior object-detection system 50 and/or the computer 12 may distinguish between parts of the occupant. For example, the interior object-detection system 50 and/or the computer 12 may identify the shoulder of the occupant as the shoulder of the occupant for use in identifying the position, location, adjustment, etc., of the shoulder belt 18 relative to the shoulder of the occupant.

The interior object-detection system 50 may identify the position of the shoulder belt 18. The interior object-detection system 50 may identify the position of the shoulder belt 18 relative to the vehicle body 20 and/or the vehicle seat 24. The interior object-detection system 50, for example, may identify the position of the upper end 42 of the shoulder belt 18 relative to the shoulder and/or torso of the occupant and/or may identify the position of the shoulder belt 18 across the torso of the occupant relative to the torso of the occupant.

The interior object-detection system 50 may include one or more image detectors for detecting objects in the occupant cabin 22. The sensors provide data about objects, e.g., occupants, lap belts 36, adjustable shoulder-belt anchors 14, etc., of the vehicle 10 to the computer 12. The sensors can be cameras 52.

The cameras 52 detect electromagnetic radiation in some range of wavelengths. For example, the cameras 52 may detect visible light, infrared radiation, ultraviolet light, or some range of wavelengths including visible, infrared, and/or ultraviolet light. For example, the cameras 52 can include image sensors such as charge-coupled devices (CCD), active-pixel sensors such as complementary metal-oxide semiconductor (CMOS) sensors, etc. The cameras 52 are configured to detect illumination ambient sources and/or from an illumination source that illuminates objects in the occupant cabin 22. In some examples, an illumination source can produce illumination in the occupant cabin 22 in some range of wavelengths, specifically, illumination detectable by the cameras 52. For example, the illumination sources may produce visible light, infrared radiation, ultraviolet light, or some range of wavelengths including visible, infrared, and/or ultraviolet light. The illumination sources are configured to produce illumination in a range of wavelengths completely or significantly encompassed by the range of wavelengths detectable by the cameras 52. For example, the illumination sources can produce and the cameras 52 can detect illumination outside a visible range, e.g., infrared illumination, e.g., near-infrared illumination (700-1300 nanometers (nm)). The illumination sources can be any suitable type for producing the desired wavelengths, e.g., for visible light, tungsten, halogen, high-intensity discharge (HID) such as xenon, light-emitting diodes (LED), etc.; for infrared light, LEDs, lasers, filtered incandescent, etc.

Sensors of the interior object-detection system 50, e.g., cameras 52 of the interior object-detection system 50, can have a field of view encompassing an area of the occupant cabin 22, e.g., one or more of the seats 24 and/or one or more occupant-seating areas 26 to view an occupant when in the occupant-seating area 26. In examples including an illumination source, the illumination source is arranged to produce illumination detectable by the cameras 52, and likewise the cameras 52 are arranged to detect illumination from the illumination sources. The cameras 52 thereby receive illumination from the illumination sources that have reflected off of objects in the occupant cabin 22.

The computer 12 may be, for example, a restraints control module. The computer 12 includes a processor and a memory. The memory includes one or more forms of computer readable media, and stores instructions executable by the processor for performing various operations, including as disclosed herein. For example, the computer 12 can be a generic computer with a processor and memory as described above and/or may include an electronic control unit ECU or controller for a specific function or set of functions, and/or a dedicated electronic circuit including an ASIC that is manufactured for a particular operation, e.g., an ASIC for processing sensor data and/or communicating the sensor data. In another example, the computer 12 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in a computer 12. The memory can be of any type, e.g., hard disk drives, solid state drives, servers, or any volatile or non-volatile media. The memory can store the collected data sent from the sensors. The memory can be a separate device from the rest of the computer 12, and the computer 12 can retrieve information stored by the memory via a network in the vehicle 10, e.g., over a CAN bus, a wireless network, etc. Use of “in response to” and “based on” herein, including with reference to the computer 12 and methods performed by the computer 12, indicates a causal relationship, not merely a temporal relationship.

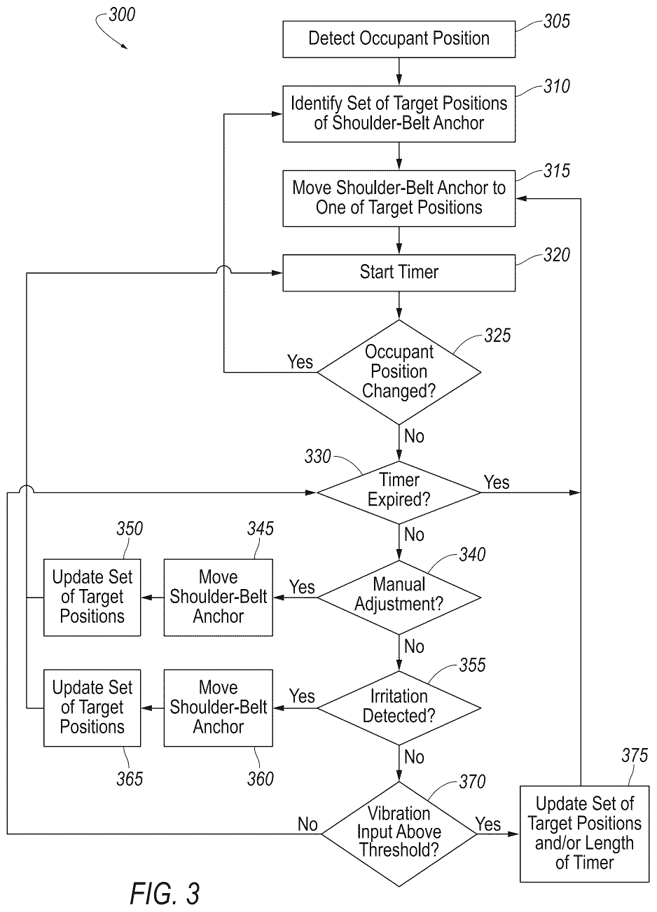

The memory of the computer 12 stores instructions executable by the processor to perform the method 300 shown in FIG. 3. In other words, the computer 12 is programmed to perform the method in FIG. 3. The memory can be of any type (e.g., hard disk drives, solid state drives, servers, or any volatile or non-volatile media). The memory can store the collected data sent from the sensors. The memory can be a separate device from the computer 12, and the computer 12 can retrieve data stored by the memory via the network in the vehicle 10 (e.g., over a CAN bus, a wireless network, etc.) Alternatively or additionally, the memory can be part of the computer 12 (e.g., as a memory of the computer 12).

The vehicle 10 includes a communication network 54 that can include a bus in the vehicle 10 such as a controller area network (CAN) or the like, and/or other wired and/or wireless mechanisms. Via the communication network 54, the computer 12 may transmit messages to various devices in the vehicle 10 and/or receive messages (e.g., CAN messages) from the various devices, e.g., sensors, an actuator, a human machine interface (HMI), etc. Alternatively or additionally, in cases where the computer 12 includes a plurality of devices, the communication network 54 may be used for communications between devices represented as the computer 12 in this disclosure. Further, as mentioned below, various controllers and/or sensors may provide data to the computer 12 via the communication 52 network.

Vehicle components that are actuatable by the computer 12 in response to image data from the interior object-detection system 50. Specifically, the motor 44 of the adjustable shoulder-belt anchor 14 is actuatable by the computer 12 in response to data from the object-detection system 50, e.g., from image data from cameras 52. The image data can be of objects that are in the field of view of one of the cameras 52. The objects can be classified into types. For example, one such type of object is a shoulder of the occupant, a head of the occupant, a torso of the occupant, a shoulder belt 18, the upper end 42 of the shoulder belt 18, an adjustable shoulder-belt anchor 14, a feature of the vehicle body 20, a feature of the seat 24, a feature of the occupant cabin 22, etc.

The computer 12 may be programmed to detect whether an object of a preset type is in the image data. For example, the computer 12 can detect the type of object using conventional image-recognition techniques, e.g., a convolutional neural network programmed to accept images as input and output an identified type. A convolutional neural network includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential type, and the final output is the type with the highest score. If the highest score belongs to the preset type, then the computer 12 has detected the object of the preset type.

For another example, the computer 12 can detect an object in the image data by using any suitable object-detection technique, e.g., knowledge-based techniques such as a multiresolution rule-based method; feature-invariant techniques such as grouping of edges (e.g., edge detection), space gray-level dependence matrix, or mixture of Gaussian; template-matching techniques such as shape template or active shape model; or appearance-based techniques such as Gaussian distribution and multilayer perceptron, neural network, support vector machine with polynomial kernel, a naive Bayes classifier with joint statistics of local appearance and position, higher order statistics with hidden Markov model, or Kullback relative information.

Based on object detection in the occupant cabin 22, the computer 12 is programmed to generate and update the set of target positions for the shoulder-belt anchor 14 to maintain the positions of the shoulder-belt anchor 14 within the set of target positions, and to periodically move the shoulder-belt anchor 14 to other positions in the set of target positions. The set of target positions is based on the position of the occupant, and the computer 12 adjusts the boundaries of the set of target positions based on movement of the occupant in the occupant cabin 22. The periodic movement of the shoulder-belt anchor 14 to other positions in the set of target positions can reduce discomfort sensed by the occupant by prolonged placement of the shoulder belt 18 across the same part of the shoulder and/or torso of the occupant.

In order to identify the set of target positions for the occupant, the computer 12 is programmed to detect the position of the occupant in the vehicle 10. The position of the occupant is detected with, for example, the interior object-detection system 50. In such examples, the interior object-detection system 50, e.g., the camera 52, communicates measurements of detection of the position of the occupant to the computer 12. The interior object-detection system 50 may identify the position of features of the occupant such as, for example, the shoulder, head, torso, etc., of the occupant. The detected position of the occupant may be measured relative to components of the occupant cabin 22, e.g., components of the body 20, the seat 24, etc.

A target position of the shoulder-belt anchor 14 is a position to which the shoulder-belt anchor 14 can be adjusted, e.g., a position of the guide 28 as moved by operation of the motor 44 by the computer 12, while allowing for operability of the seatbelt assembly 16 and comfort of the occupant. A target position is a physical position of the shoulder-belt anchor 14, e.g., a position of the guide 28 of the shoulder-belt anchor 14. The target position may be a position of the shoulder-belt anchor 14, e.g., the guide 28, relative to the vehicle body 20, the seat 24, and/or an anatomical feature of the occupant, e.g., a shoulder, head, torso, etc. The target positions of a set of target positions are arranged generally vertically so that each target position is above or below another target position. The set of target positions includes one or more ranges of target positions and/or a plurality of discrete target positions. The set of target positions includes an upper boundary, i.e., the uppermost target position of the set of target positions for the shoulder-belt anchor 14, and a lower boundary, i.e., the lowermost target position of the set of target positions for the shoulder-belt anchor 14.

The computer 12 is programmed to identify a set of target positions of the shoulder-belt anchor 14 of the seatbelt assembly 16 based on the position of the occupant. Specifically, the target positions of the set of target positions are identified for operability of the seatbelt assembly 16 and comfort of the occupant. After determining the position of the occupant, the computer 12 may identify the upper boundary and the lower boundary of the set of target positions of the shoulder-belt anchor 14 that allow for operability of the seatbelt assembly 16 and comfort of the occupant. The upper boundary and the lower boundary may be determined based on the position of an anatomical feature of the occupant, e.g., a shoulder, head, torso, etc. The upper boundary and the lower boundary for operability and comfort may be, for example, based on empirical data, e.g., based on a lookup table with positions of one or more anatomical features of the occupant relative to a component of the vehicle 10 such as a component of the occupant cabin 22, the seat 24, etc.

The computer 12 may be programmed to dynamically identify the set of target positions based on movement of the occupant. In other words, when the occupant moves a sufficient amount relative to a component of the vehicle 10, such as a component of the occupant cabin 22, the seat 24, etc., the computer 12 updates the set of target positions for the new position of the occupant. The passenger may move by slouching, sitting straight, leaning to one side, adjusting a seat 24 upon which the occupant is seat 24ed, etc.

The computer 12 is programmed to move the shoulder-belt anchor 14 to be at one of the target positions. Specifically, after the set of target positions is identified based on the position of the occupant, the computer 12 moves the shoulder-belt anchor 14 in the event the shoulder-belt anchor 14 is at a position outside of the set of target positions. For example, the computer 12 is programmed to activate the motor 44 to move the guide 28 relative to the body 20 of the vehicle 10. In examples in which the computer 12 updates the set of target position based on movement of the occupant, the computer 12 is programmed to determine whether the position of the shoulder-belt anchor 14 is outside of the set of target positions, and if so, to move the shoulder-belt anchor 14 to be at one of the target positions. Movement of the shoulder-belt anchor 14 moves the upper end 42 of the shoulder belt 18 relative to the occupant.

The computer 12 is programmed to periodically move the shoulder-belt anchor 14 between various ones of the target positions of the set of target positions. The periodic movement of the shoulder-belt anchor 14 periodically adjusts the shoulder belt 18 across the occupant, which can reduce discomfort sensed by the occupant by prolonged placement of the shoulder belt 18 across the same part of the shoulder and/or torso of the occupant. The periodic movement can be at a regular time interval or an irregular time interval.

In some examples, the frequency of periodic movement can be changed based on driving conditions, occupant preference, etc. As one example, the computer 12 may be programmed to modify the frequency of periodic movement of the shoulder belt 18 based on vibration of a body 20 of the vehicle 10. As an example, during operation of the vehicle 10 on a driving surface that generates vibration of the vehicle 10 (e.g., during trailering, operation on a dirt road, etc.), the computer 12 may be programmed to increase the frequency of the periodic movement of the shoulder belt 18. The computer 12 may be programmed to decrease the frequency of the periodic movement of the shoulder belt 18 during subsequent operation of the vehicle 10 on a driving surface that results in a reduction of vibration of the vehicle 10. The vibration of the vehicle 10 from the driving surface may be detected, for example, by an inertial measurement unit (IMU), or in any other suitable way, including, in some examples, those that are known.

The computer 12 is programmed to update the set of target positions based on user-based input. The updates based on user-based input can include elimination of target positions from the set of target positions and can include identification of preferred target positions. User-based input can include manual input from the occupant (e.g., through the user-input device 46) and/or detected input (e.g., from the object-detection system 50). User-based inputs include inputs entered by the user or detected from user movement indicating dislike of a position of the shoulder-belt anchor 14 and the corresponding position of the shoulder belt 18 across the occupant.

The computer 12 is programmed to update the set of target positions based on detection of indicators of irritation of the occupant by the shoulder belt 18. Irritation of the occupant may be caused by rubbing of the shoulder belt 18 on the body 20 of the occupant and/or prolonged contact of the shoulder belt 18 in a single position on the occupant.

For example, manual input from the occupant includes manual adjustment of the position of the shoulder-belt anchor 14. For example, the computer 12 may be programmed to identify that manual adjustment of the position of the shoulder-belt anchor 14 away from a position as an indication of irritation of the shoulder belt 18 on the body 20 of the occupant in that position of the shoulder belt 18. The computer 12 may be programmed to identify the manual adjustment of the position of the shoulder-belt anchor 14 to a position as an indication of lack of irritation of the shoulder belt 18 on the body 20 of the occupant in that position. The computer 12 may use repeated manual adjustment of the shoulder-belt anchor 14 away from a position or to a position as confirmation of the dislike or the preference of the respective position, i.e., irritation or lack of irritation.

Another example of detection of indicators of irritation of the occupant by the shoulder belt 18. Detection of irritation of the occupant by the shoulder belt 18 may include, as set forth above, detected input detected from the object-detection system 50, e.g., cameras 52. The computer 12 may update the set of target positions based on detection of images indicating irritation of the occupant by a shoulder belt 18 of the seatbelt assembly 16. For example, the object-detection system 50 may detect lifting and/or pulling of the shoulder belt 18 on the shoulder or torso of the occupant by the hand of the occupant. In such examples, the object-detection system 50 may detect the belt, e.g., by object-detection techniques described above, and may detect movement of the shoulder belt 18 when lifted and/or pulled with the hand of the occupant. In addition or in the alternative, the object-detection system 50 may detect the hand of the occupant on the shoulder belt 18, e.g., by object-detection techniques described above, and may detect movement of the hand and/or shoulder belt 18 during lifting and/or pulling of the shoulder belt 18 by the hand relative to the body 20 of the occupant. The computer 12 may be programmed to identify the lifting and/or pulling of the shoulder belt 18 as an indication of irritation of the shoulder belt 18 on the body 20 of the occupant in that position of the shoulder-belt anchor 14. The computer 12 may use repeated lifting and/or pulling of the shoulder belt 18 while the shoulder-belt anchor 14 is in one position as confirmation of the irritation of the shoulder belt 18 in that position.

The identification of a set of target positions of a shoulder-belt anchor 14 includes updating the set of target positions based on the detection of indicators of irritation of the occupant by the shoulder belt 18. Specifically, discrete target positions and/or ranges of target positions in the set of target positions can be eliminated from the set of target positions based on detection of indicators of irritation of the occupant by the shoulder belt 18. As set forth above, the indicators include, for example, manual movement of the shoulder-belt anchor 14 away from a position and/or detection of lifting and/or pulling of the shoulder belt 18 by the hand of the occupant. Based on such indicators of irritation, the computer 12 may eliminate target positions associated with indicators of irritation.

The computer 12 may store the set of target positions, including updates to the set of target positions based on detection of indicators of irritation. The set of target positions may be associated with a position of the occupant, i.e., relative to the seat 24 and/or vehicle body 20 in the occupant cabin 22. In the event the occupant moves in the occupant cabin 22, the computer 12 may apply the set of target positions based on the location of the occupant at a position and/or based on the location of the occupant being within a range of positions. The computer 12 may dynamically apply different sets of target positions based on movement of the occupant.

The computer 12 may store the set of target positions, including updates as described above, for use with occupants in the same or similar positions. In some examples, the computer 12 may store the set of target positions for a particular occupant. In such examples, the occupant may be identified by a user account (e.g., Ford Pass), facial recognition, etc. In the event the identification of the occupant is recognized, the computer 12 may apply previously saved sets of target positions for that occupant. In examples in which the sets of target positions are saved for a particular occupant on a user account, e.g. Ford Pass, the previously saved sets of target positions may be applied for that occupant in different vehicles that recognize the occupant. In such examples, previous positions of the occupant in previous uses of a vehicle, e.g., often used or preferred positions of that occupant, may be saved and used for future application of sets of target positions. For example, based on recognition of the identification of an occupant entering the vehicle, the computer 12 may initially adjust the position of the shoulder-belt anchor 14 to a position associated with often-used positions occupant (e.g., seat 24 position, occupant posture, etc.) in previous occupations of the vehicle.

The computer 12 may receive input from the occupant to adjust the position of the shoulder-belt anchor 14. As an example, the computer 12 may receive input from the occupant through the user-input device 46 to selectively raise or lower the adjustable shoulder-belt anchor 14 to a position desired by the occupant. In some examples, the computer 12 may limit manual adjustment of the shoulder-belt anchor 14 by the occupant to a position within the set of target positions. For example, the computer 12 may limit movement of the shoulder-belt anchor 14 to positions within the set of target positions and ignore requests through the user-input device 46 to move the shoulder-belt anchor 14 to a position outside of the set of target positions. In other examples, the computer 12 may provide recommendations for positions of the shoulder-belt anchor 14 based on the set of target positions for the position and/or identification of the occupant in the vehicle 10. As an example, in response to input by the occupant to manually adjust the position of the shoulder-belt anchor 14, the computer 12 may recommend a position to which the occupant can choose to adjust the shoulder-belt anchor 14. For example, the recommendation may be provided through a display 48 (described above) and/or audibly. In some examples, the computer 12 may provide instructions to the vehicle 10 to limit operation of vehicle 10 based on manual adjustment of the shoulder-belt anchor 14 to a position outside of the set of target positions. For example, in the event an occupant manually adjusts the shoulder-belt anchor 14 to a position outside of the set of target positions, the computer 12 may instruct the vehicle 10 to provide a warning to the occupant (e.g., audibly, through the display 48, etc.) and/or to prevent engagement of the vehicle 10 from a park position to a drive position.

FIG. 3 shows a method 300 performed by the computer 12. The method 300 includes detecting an occupant position. As set forth above, the position of the occupant may be detected with the object-detection system 50. Based on the occupant position, the method includes identifying a set of target positions of the shoulder-belt anchor 14 in block 310. The method 300 then includes moving the shoulder-belt anchor 14 to one of the target positions in block 315.

In block 320, the method 300 includes starting a timer. The timer provides timing for the periodic adjustment of the position of the shoulder-belt anchor 14, as described above. The timer may be of any suitable type. The computer 12 may control the timer to operate on the frequency of periodic adjustment as described above.

In decision block 325, the method 300 includes determining if the occupant position has changed. As set forth above, changes in the occupant position may be detected with the occupant-detection system. If the occupant position changes to a degree that triggers an identification of an updated set of target positions, then the method 300 returns to block 310. The computer 12 may, for example, determine whether the occupant has moved more than a threshold amount of movement that precipitates an identification of an update. The threshold amount may be based on a formula, algorithm, lookup table, etc.

In decision block 330, the method 300 determines whether the timer expired. In the event the timer has expired at block 330, the shoulder-belt anchor 14 is moved to another position in the set of target positions. The position may be identified based on position preference determined from user-based input, as described above. In the example method 300 shown in FIG. 3, the method 300 returns to block 315 for movement of the shoulder-belt anchor 14 in response to expiration of the timer.

In decision block 340, the method 300 may receive input from the occupant for manual adjustment of the position of the shoulder-belt anchor 14. In response to input from the occupant for manual adjustment, the method 300 proceeds to move the shoulder-belt anchor 14, as shown in block 345. As described above, the computer 12 300 may recommend and/or limit positions for adjustment of the shoulder-belt anchor 14 in response to input by the occupant for manual adjustment. In block 350, the method 300 includes updating the set of target positions based on the manual adjustment, as described above. The method 300 proceeds from block 350 to block 320. Specifically, the timer may be restarted after the set of target positions is updated in block 350.

In decision block 345, the method 300 may receive detection of indication of irritation of the occupant by the shoulder belt 18. In response to indication of irritation, the method 300 proceeds to move the shoulder-belt anchor 14, as shown in block 360. Specifically, the shoulder-belt anchor 14 is moved to another position of the set of target positions. In block 365, the method 300 includes updating the set of target positions based on the indication of irritation, as described above. The method 300 proceeds from block 365 to block 320. Specifically, the timer may be restarted after the set of target positions is updated in block 365.

In decision block 370, the method 300 includes determining whether vibration input is above threshold. As described above, the detected vibration of the vehicle body 20 may be measured by the IMU. As shown in block 375, based on the detected vibration of the body 20, the method 300 may include altering the frequency of periodic adjustment of the shoulder-belt anchor 14 based on vibration of the vehicle body 20, as described above.

In general, the computer 12 may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

The computer 12 generally includes computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer 12 readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer 12 can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computer 12s, etc.), stored on computer readable media associated therewith (e.g., disks, memories, etc.). A computer 12 program product may comprise such instructions stored on computer readable media for carrying out the functions described herein.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A computer having a processor and memory storing instructions executable by the processor to:
detect a position of an occupant in a vehicle;
identify a set of target positions of a shoulder-belt anchor of a seatbelt assembly based on the position of the occupant; and
periodically move the shoulder-belt anchor between various ones of the target positions.

2. The computer as set forth in claim 1, wherein the instructions include instructions to update the set of target positions based on user-based input.

3. The computer as set forth in claim 1, wherein the instructions include instructions to update the set of target positions based on detection of indicators of irritation of the occupant by a shoulder belt of the seatbelt assembly.

4. The computer as set forth in claim 1, wherein the instructions include instructions to update the set of target positions based on detection of images indicating irritation of the occupant by a shoulder belt of the seatbelt assembly.

5. The computer as set forth in claim 1, wherein the instructions include instructions to update the set of target positions based on manual adjustment of a position of the shoulder-belt anchor by the occupant.

6. The computer as set forth in claim 1, wherein the instructions include instructions to modify the frequency of periodic movement of the shoulder belt based on vibration of a body of the vehicle.

7. The computer as set forth in claim 1, wherein the instructions include instructions to update the set of target positions based on a change in the position of the occupant in the vehicle.

8. The computer as set forth in claim 1, wherein the instructions include instructions to update the set of target positions based on:
detection of images indicating irritation of the occupant by a shoulder belt of the seatbelt assembly;
manual adjustment of a position of the shoulder-belt anchor by the occupant; and
change in the position of the occupant in the vehicle.

9. A method comprising:
detecting a position of an occupant in a vehicle;
identifying a set of target positions of a shoulder-belt anchor of a seatbelt assembly based on the position of the occupant; and
periodically moving the shoulder-belt anchor between various ones of the target positions.

10. The method as set forth in claim 9, further comprising updating the set of target positions based on user-based input.

11. The method as set forth in claim 9, further comprising updating the set of target positions based on detection of indicators of irritation of the occupant by a shoulder belt of the seatbelt assembly.

12. The method as set forth in claim 9, further comprising updating the set of target positions based on detection of images indicating irritation of the occupant by a shoulder belt of the seatbelt assembly.

13. The method as set forth in claim 9, further comprising updating the set of target positions based on manual adjustment of a position of the shoulder-belt anchor by the occupant.

14. The method as set forth in claim 9, further comprising modifying the frequency of periodic movement of the shoulder belt based on vibration of a body of the vehicle.

15. The method as set forth in claim 9, further comprising updating the set of target positions based on a change in the position of the occupant in the vehicle.

16. The method as set forth in claim 9, further comprising updating the set of target positions based on:
detection of images indicating irritation of the occupant by a shoulder belt of the seatbelt assembly;
manual adjustment of a position of the shoulder-belt anchor by the occupant; and
change in the position of the occupant in the vehicle.
